(19) United States
(12) Patent Application Publication
(10) Pub. No.: US 2004/0097285 A1
(43) Pub. Date: May 20, 2004

(54) Anti-cheating device for a gaming machine

(76) Inventors: Ken Scott Fisher, Los Angeles, CA (US); Kevin Cotton Baxter, Santa Clarita, CA (US)

Correspondence Address: KEN FISHER, 5521 CLEON AVE., NORTH HOLLYWOOD, CA, 91601, US

(21) Appl. No.: 10/238,561

(22) Filed: Sep. 10, 2002

(51) Int. Cl. G06F 17/00

(52) U.S. Cl. 463/24; 463/46

(57) ABSTRACT

An anti-cheating device for a gaming machine, which prevents or detects the insertion of a cheating device through a hole or seam. In a first preferred embodiment, an assembly links a more sensitive local alarm system across to an independent central alarm system. An attempt to create a small opening by slightly offsetting a gaming device's door, to allow insertion of a cheating device through the newly created seam results in a central system alarm or a “tilt” of the machine. In another preferred embodiment, a protective guard prevents access to the system reset mechanism by an elongated cheating device, thereby preventing manipulation of the reset button.

### BACKGROUND OF THE INVENTION

1. Field of the Invention

The present invention relates to anti-cheating devices for gaming machines. More particularly, but not by way of limitation, the present invention relates to an anti-cheating device for a slot machine, or the like, which detects or prevents unauthorized access to the system reset mechanism.

2. Background of the Invention

Gaming machines such as slot machines, draw poker machines, bingo machines, and the like are prevalent in casinos around the world. Such machines deal primarily in cash, tend to accumulate rather large sums of cash before collections are made, and, since all of the money is not removed from a machine in service, theft is difficult to detect. Thus, these machines are prime targets for tampering.

In an Associated Press article dated Nov. 25, 1999, it states: “Authorities arrest an average of 600 cheaters a year in Nevada—people like Dennis McAndrew, formerly known as Dennis Nikrasch. He masterminded two slot cheating schemes that netted $16 million, two of the biggest scams in Nevada history.” In a further excerpt from the same article it states: “. . . gang of local cheats who have taken $5 million from casinos over the last 10 years. Even though they've been arrested, they haven't been prosecuted because conspiracy is difficult to prove.” Articles such as this point to the need for increased security within the gaming industry. In addition, with the advent of the web, it is known that numerous underground web sites exist that share various coin operated cheating techniques, thus information previously known only by a few, can now be disseminated and used by many.

The evolution of cheating devices has, thus far, kept pace with the evolution of gaming machines. Techniques and devices were developed for tampering with purely mechanical slot machines. Methods included the use of magnets, drilling or cutting holes in the enclosure of the machine, using counterfeit “slugs”, or even a coin on a string. As gaming machine manufacturers replaced mechanical assemblies with electronic alternatives, cheating devices were developed to cheat these machines as well. For example, a generation of gaming machines employed mechanical devices to time the reels but used electronic circuitry to pay-out coins.

Over the past several years, gaming machine manufacturers have replaced the vast majority of mechanical components employed in such machines with electronic circuitry. Programmable circuits, especially microprocessor devices, have allowed manufacturers to incorporate a number of anti-cheating devices and methods that deter such cheating. For example, modern slot machines include a coin comparator, which compares the magnetic signature of an inserted coin against the signature of a reference coin. Such devices are effective in preventing a person from using counterfeit coins or slugs. A further example of an existing anti-tampering device is the optical coin counter used in the majority of modem slot machines. This device provides three LED's, which emit light across a coin path to three detectors. After a coin has been successfully compared, it falls through the coin path, sequentially disrupting the light striking the detectors. If a coin does not properly break the beams (e.g., traveling in the wrong direction through the coin counter as would a coin on a string), the counter produces an output that “tilts” the slot machine thereby alerting casino workers and disabling the machine.

From an overview standpoint, most gaming devices in use today have mechanical coin “hoppers” to dispense a winners earning. Such devices handle large quantities of coins, and are prone to jamming, and as such, require frequent testing to insure optimum performance. This is typically accomplished by using the system-reset button to put the hopper into a “test” mode. In order to initiate the test mode, the machine must sense that the primary door sensor is showing an “open door state”, and the reset button must be pushed the “correct” number of times. This reset button is usually located on the system's circuit board (with may be surrounded by an encasement), inside the gaming machine itself. The switch may be a board mounted, push-button style, approximately 6 mm (¼″) in diameter or less, and is usually located near the door hinge. To test the hopper, typically a casino maintenance worker will first make a call to security, notifying them that a particular machine door is about to be opened, after then opening the door, he or she then presses the system reset button a “fixed” number of times, at which point the machine is put into the aforementioned “test” mode. The maintenance person then proceeds to push the spin reel button, or pull down on the handle, at which time the machine (if the button or handle is still held down) will continuously dispense coins from the hopper, so as to test its functionality.

A cursory understanding of alarm systems for coin operated gaming systems may be helpful in better defining the invention described herein. One well-known manufacturer of coin operated gaming devices is International Gaming Technology (IGT) of Las Vegas, Nev., USA, www.igt.com. Most such gaming devices when in actual use have two separate (and fully independent) alarm systems. The dual alarm approach used by many casinos is outlined as follows:

System #1) The primary alarm system typically consists of the following: A factory installed, integrated “local” alarm system, typically consisting of an optical-based door sensor (e.g., a photo detector and phototransistor, pointed towards each other), control circuitry and an attached visual alarm indicator. The components of door sensor itself are typically placed: one on the door itself (e.g., on or near the latch); and the other on the main body of the gaming machine. In addition to sensing an open door state, this door sensor system typically can even detect a small “lateral” shift in the door, with respect to the enclosure body (e.g., door and main enclosure misalignment). Whatever the cause, when the internal door sensor detects an open or “shifted” state, it only turns on a local visual alarm, typically located on the top of the gaming device (commonly referred to as the “candle”), and it may also put the machine into a “tilt” state. Restated, this is a self-contained localized alarm system.

System #2) The secondary alarm system typically consisting of the following: A customer (e.g., a casino) or third party installed door alarm sensor(s), usually consisting of a “dry contact” or “open circuit” switch (e.g., a 99¢ refrigerator-door switch), which is then connected to a “central” alarm system. Tripping the central alarm switch, by opening the door, for example, would thereby trigger the central security system, and typically focus all available cameras and eyes on the offending machine (e.g., in a casino setting), as well as warranting an inspection by security personnel. It is important to note that this central “non-factory” alarm system does not interface with aforementioned “localized” alarm system.

Since the primary local door alarm sensor (e.g., optical based) tends to use more sophisticated technology, it is much better at sensing basic “tampering”, when compared to the more simplified central station “refrigerator” door style switch.

While these devices perform satisfactorily to prevent tampering in limited areas, they are wholly ineffective in discouraging cheating by the sophisticated thief, using refined techniques and specially made cheating tools. It is known that more professional thieves maintain “slot machine laboratories”, which are used to practice and refine their theft techniques and tools. These laboratories may be outfitted with the exact same machines that casinos have, which in-fact are readily available thru gaming device dealers (e.g., both new and used). Such tools are typically inserted either through existing holes or through the gaps that are created (e.g., between the door and enclosure), and can be exploited to manipulate the reset button inside the gaming machine. For example, it is known that a tool may be formed from a thin elongated wire, which may be inserted in a gap crack created when a would-be thief slightly raises the door of a slot machine (e.g., places his knee under the coin tray, and raises his leg in an upward fashion). While only disclosing enough of the mechanics of defeating the existing anti-cheating devices, so as to properly explain the invention described herein, it has been demonstrated that such a shift in the door is only detected by the local door alarm sensor, thereby turning on visual alarm (e.g., candle), and likely activation of the system's “tilt” mechanism. The central contact door switch is unaffected by this slight shift of the door.

Many “creative” ways also exist to disable the relatively simple visual “candle”. One such way is to place an opaque, but matching, candle cover over the existing candle. The combination of the internal door sensor showing open, along with insertion of the tool through the newly formed gap, creates a fatal flaw in the system, whereby one is then able to gain access to the reset button and put the machine into the hopper test mode, which could then dispense all of the contents of the coin hopper (as long as the spin reel or handle is held down). This is allowed by the system's control circuitry, because the required conditions have been met: 1) the primary local door sensor is showing an “open door state”; 2) the reset button was pushed the “correct” number of times. Such a cheating approach can rapidly accumulate hundreds, or even thousands of dollars from the machine.

Many manufacturers have attempted to counteract theft by placing additional “central” alarm switches, which is totally ineffective against the techniques described above. Since money is always left in the machine (and hidden from view in an opaque coin bin), the actual theft can easily go undetected.

It should be noted that there exists millions of machines in the world today, that are venerable to such a cheating approach noted above, and to make matters worse, these same machines have their system reset switches placed directly adjacent to the venerable door seam. Recently, some manufacturers have relocated the reset switch away from the door seam. It is known that slot cheats have also devised ways to access the relocated reset position, some of which are detailed below.

In another example of sophisticated cheating, a tool (e.g., playing card, which is able to make the bend) is pushed through the door seam, to temporarily disable the central alarm switch button. Such an approach may allow the cheat (or unscrupulous casino worker) to then open the door and quickly set the machine into the aforementioned hopper test mode. Thus, a thief will again be able to disgorge the contents of the machine.

While a given cheating tool may only be usable on a specific model of gaming machine, modifications may be made to create a similar tampering device for all known gaming machines. Thus, a thief armed with a relatively small assortment of tools can quickly cheat an array of machines, taking substantial amounts of cash in a relatively short period of time. Cheating tools tend to be relatively small and often formed mainly from simple metallic or transparent materials. An experienced thief can easily carry and use such tools with little risk of detection.

Heretofore, a barrier has essentially existed to increase the security on millions of existing gaming machines to counteract today's more sophisticated thieves.

As a result, a need exists in the art for a method and apparatus that provides a much higher level of system security.

It is thus an object of the present invention to provide an anti-cheating device that prevents or detects the insertion of a cheating device through a hole or seam gap of a gaming machine.

It is further an object of the present invention to provide a means of close proximity protection for the system reset button.

It is still a further object of the present invention to provide an anti-cheating device for a gaming machine, which may be easily incorporated into a new or existing machine.

### 3. SUMMARY OF THE INVENTION

The present invention provides an anti-cheating device for a gaming machine that satisfies the needs and alleviates the problems mentioned above. In a preferred embodiment, the anti-cheating device prevents or detects the insertion of a cheating device through a gap in a gaming machine. Known cheating schemes and devices, which successfully defeat the local and central alarm systems, by only slightly offsetting the door, and then employing a wire tool to: 1) “Set” the system into a hopper test mode; 2) Dispense the monetary contents of the machine. Thus, the successful insertion of such a device may be prevented by combining the normally independent central alarm system, with the more sensitive local alarm door sensor, so as to immediately notify the appropriate authorities of an attempted incursion, or alternatively, providing a protective guard cover for the system reset mechanism, while the machine door is closed.

For the purposes of this invention, the terms “anti-cheating” and “anti-tampering” are used interchangeably as are the terms “cheat” or “cheating” and “tamper” or “tampering”. The terms “cheat” or “cheating” and “tamper” or “tampering” are in used reference to the manipulation (e.g., by an individual) of a gaming machine to cause the machine to pay-out money either when no money is due to be paid out or in excess amounts when the machine attempts to legitimately pay-out money. The terms “anti-cheating” and “anti-tampering” refer to devices or methods for preventing cheating or tampering.

In another preferred embodiment, the anti-cheating device detects (or all together blocks) the presence of a cheating tool inserted through the door gap by providing a sensing system (e.g., micro switch, or array of emitters and detectors) and/or a blocking means, on or about the door seams. Disruption of a switch, or an energy beam emitted by the emitters and normally striking the detectors will, based on the machine owner's preference, result in one or more of: a “tilt” condition of the machine; an immediate flag of the machine for service; a disabling of the coin feeder; and/or an alarm. Sensing may automatically disable the machine through the machine tilt detection system. This tilt approach may also be used with any of the other embodiments described herein.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### 4. BRIEF DESCRIPTION OF THE DRAWINGS

The present invention is illustrated by way of example and not by way of limitation in the figures of the accompanying drawings in which references indicate similar elements and in which:

FIG. 1 provides a front view of a gaming machine wherein a preferred embodiment inventive anti-cheating device is incorporated in its general environment.

FIG. 2 provides a front internal view of a gaming machine.

FIG. 3 provides a rear view of the door of a gaming machine having a coin handling assembly attached thereto.

FIG. 4 provides a block and wiring diagram according to the invention.

FIG. 5 provides a perspective view of a coin hopper and coin feeder typically employed in a gaming machine.

FIG. 6 provides a top view of the door based reset button cover with the door open.

FIG. 7 provides a top view of the door based reset button cover with the door closed.

FIG. 8 provides a perspective view of the circuit board enclosure based hinged cover for a reset button.

### 5. DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation. It should also be observed that the present invention resides primarily in what is effectively a novel combination of anti-cheating components, and not in the particular detailed configurations thereof. Accordingly, the arrangement of the circuits and components have been illustrated in the drawings by readily understandable block and wiring diagrams, which show only those specific details that are pertinent to the present invention, so as not to obscure the disclosure with structural details which will be readily apparent to those skilled in the art having the benefit of the description herein. Thus, the diagram illustrations of the Figures do not necessarily represent all of the structural arrangements of the exemplary system, but are primarily intended to illustrate the major structural components of the system in a convenient functional grouping, whereby the present invention may be more readily understood.

While the preferred embodiment of the inventive device is hereinafter shown and described as being incorporated in a slot machine, it should be understood that the invention is not so limited and is applicable to all gaming machines and, in fact, aspects of the invention are applicable to many types of coin operated devices.

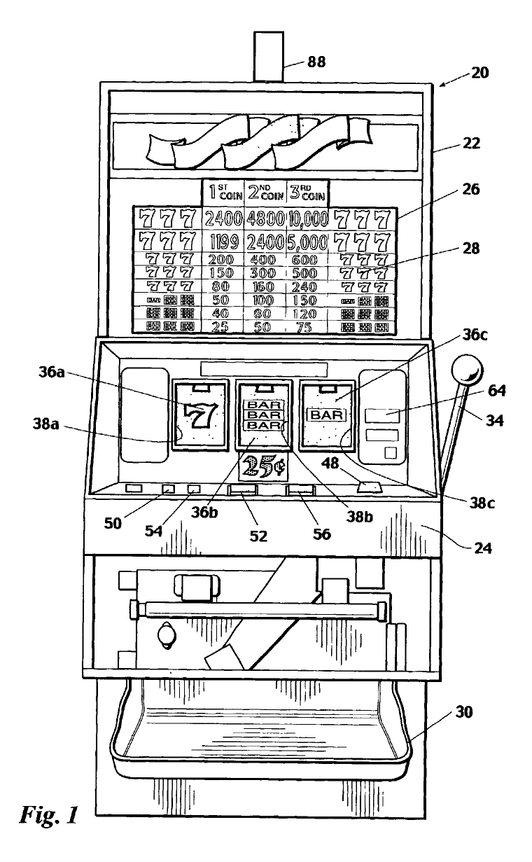

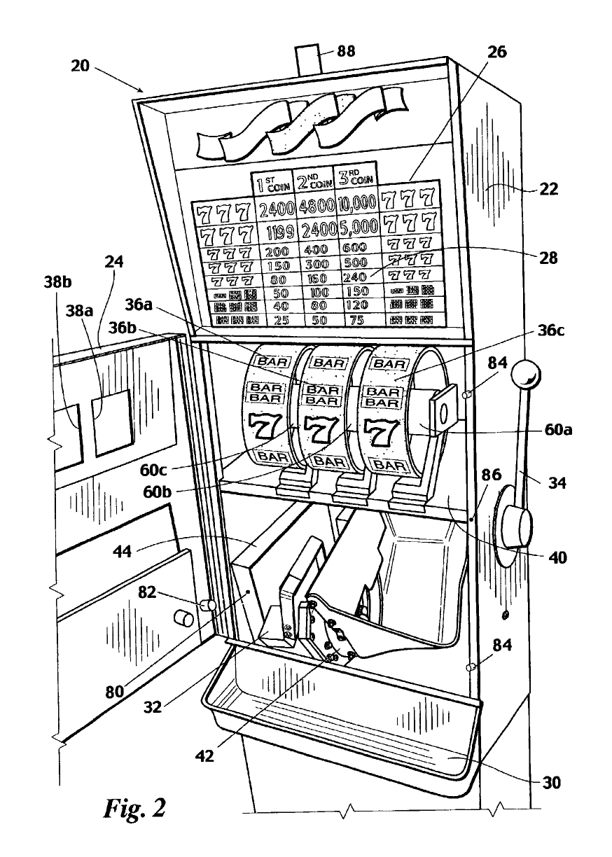

Referring now to the drawings, wherein like reference numerals indicate the same parts throughout the several views, a preferred embodiment of the inventive anti-cheating device is incorporated into a slot machine 20 as shown in FIG. 1. Preferably, slot machine 20 comprises: an outer enclosure 22 having a door 24; a top portion 26 whereon is displayed jackpot information 28, a coin tray 30 located beneath chute 32 (FIG. 2) for receiving coins paid out by machine 20; a local visual alarm “candle” 88; a handle 34 for activating a “play”; and reels 36a-c which show through corresponding window 38a-c in door 24.

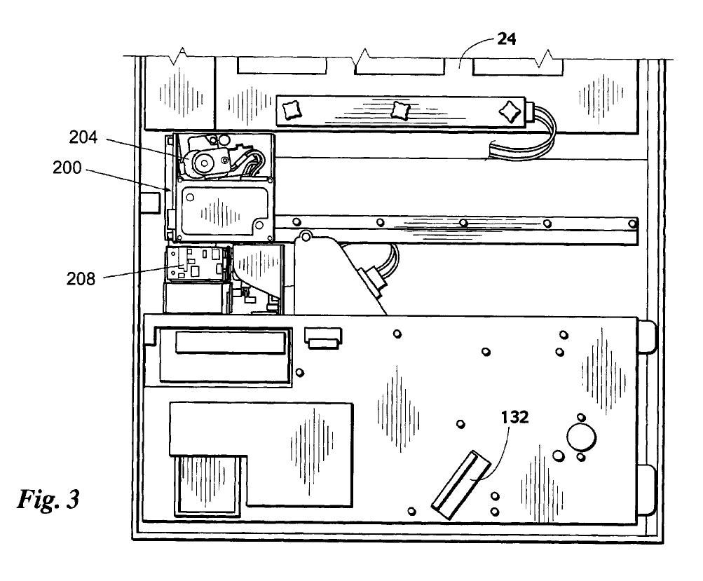

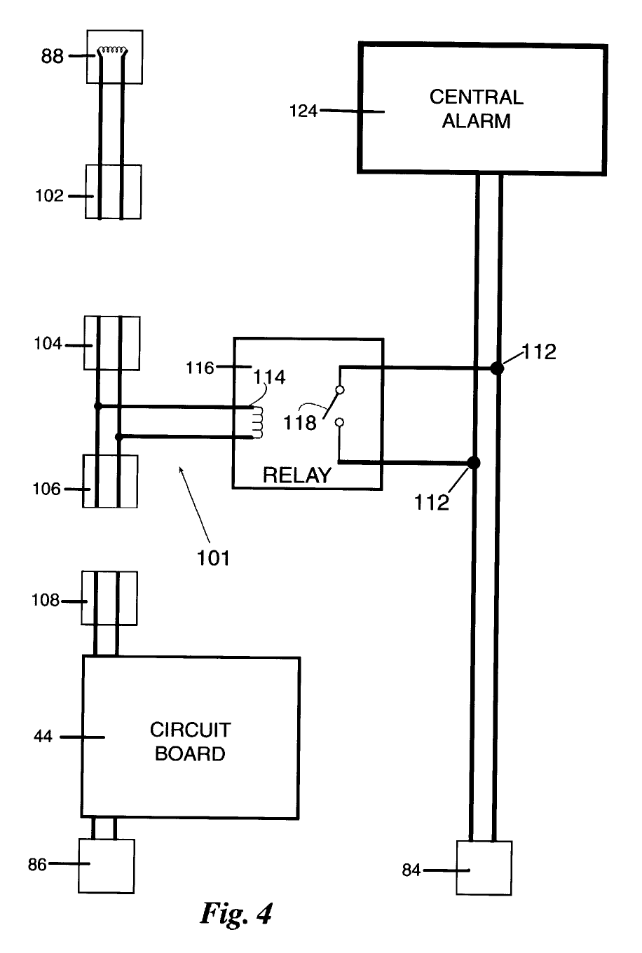

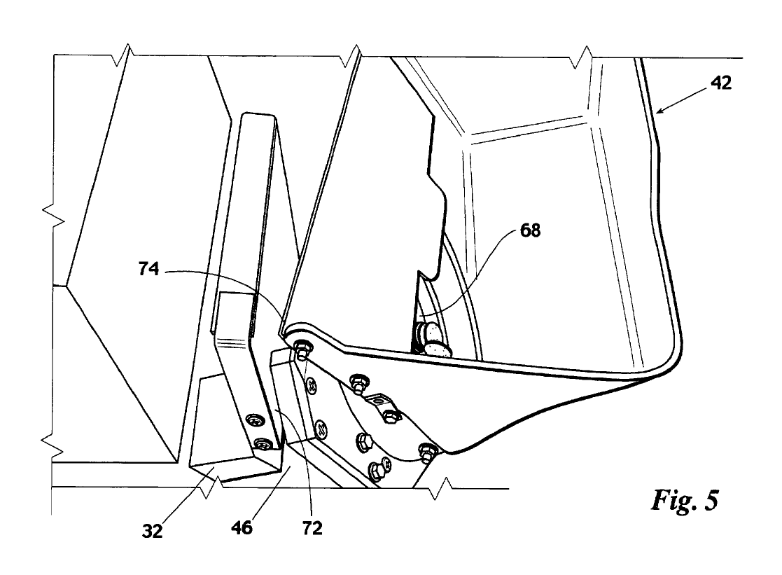

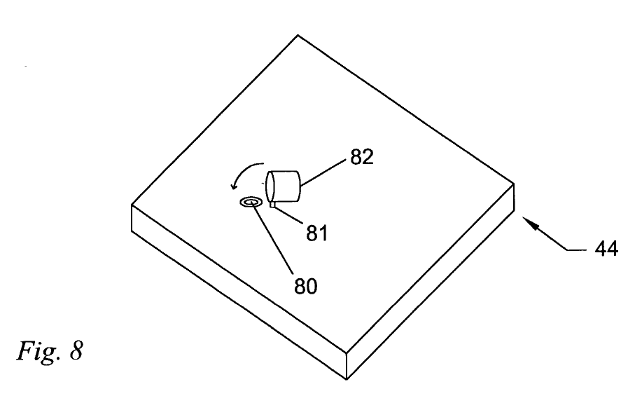

Continuing with FIG. 1 and with further reference to FIG. 2, enclosure 22 houses: shelf 40 which supports reels 36a-c; coin hopper/feeder assembly 42 for discharging coins through dispenser chute 32 and coin chute 132 (FIG. 3), into tray 30; and electronic circuit board assembly 44 which provides outputs to reel motors 60a-c to selectively spin reels 36a-c and coin feeder motor 46 (as best seen in FIG. 5), as well as inputs for buttons 50, 52, 54, and 56 on door 24, for a switch (not shown) operably connected to handle 34, for coin handler assembly 200 (FIG. 3), an front mounted reset switch 80 (FIG. 2) or side mounted as depicted in FIG. 8, one or more central alarm switches 84, local alarm switch assembly 86 (FIGS. 2 and 4), and various tilt sensors. Shaft encoders (not shown) are in rotational communication with reels 36a-c and produce a signal received by circuit board assembly 44 whereby each reel 36a-c can be precisely stopped to display the portion of each reel 36a-c through windows 38a-c, respectively, as determined by circuit board assembly 44. If circuit board assembly 44 calls for a jackpot, reels 36a-c are stopped to correspond to a pay-out as indicated in the jackpot information 28 and the appropriate number of credits are displayed in window 64 on door 24. It should be noted that electronic circuit board assembly 44 typically has a metallic enclosure to reduce radio frequency (RF) interference. Referring to FIG. 5, the system may also have hopper disk 68, coin detector 74, and coin channel 72.

To operate the machine, a user typically begins by dropping coins or tokens in coin slot 48. A reference coin 204 (FIG. 3) is shown in coin handler 200, which is connected to optical coin counter 208 so as to be counted for a system check. Next, the user pulls handle 34 to activate a “play”. Upon pulling the handle, the circuitry on circuit board assembly 44 determines where reels 36a-c should stop, enables power to reel motors 60a-c, and then one-by-one stops reels 36a-c at the predetermined position after a predetermined period of time. If a jackpot is indicated, circuit board assembly 44 adds the appropriate number of credits to the number displayed in window 64. If credits are shown, the user may use credits in lieu of coins by pressing button 54 on door 24 or may play three credits and activate a play by pressing button 56. In addition, the user may initiate a play by pressing button 52 rather than pulling handle 34.

It is known that slot cheats have created gaps, e.g., at the bottom of the door hinge, (or used existing holes) on slot machines 20 to gain access to the reset button 80, so as to trick the slot machine into paying out all the coins in the hopper 42, under the well known “hopper test” mode. Referring to FIG. 2, the system-reset button 80 is located on the circuit board assembly 44, and is typically situated very near the seam of door 24, for easy access by maintenance workers. The slot cheat may first disable the visual alarm indicator 88 (e.g., by dropping an opaque but matching cover over the “candle”). The thief may then leverage their knee under the shelf 30, adjacent to door 24, and by pressing upwards, the door will “twist” slightly, creating a gap sufficiently wide for the insertion of a wire tool, and only tripping the internal alarm system switch 86. The machine's internal system now thinks the door 24 is open, and has turned on the “candle” 88, indicating a door open situation. Because candle 88 may be covered (or otherwise disabled), there is no indication elsewhere to the contrary. The central door alarm switch 84 (e.g., dry contact) is left undisturbed (e.g., door 24 is being pushed “up” and not “out”), central alarm switch(es) 84 does not signal an incursion, and as such, does not then set off the central alarm system 124 (FIG. 4). This is critical to a thief because tripping the central alarm would typically trigger the security system to focus all available cameras, and eyes on the offending machine. The cheat now inserts a wire “tool” into the small gap created at the bottom of the door's hinge and may proceed to activate the adjacent reset button 80. By pushing reset button 80 a “known” number of times, in rapid secession, and pressing button 52 or pulling down on the pull-handle 34, the hopper's mechanism 42 will then be tested. As long as the handle 34 or button 52 is held in the down position, hopper 42 disgorges its' contents via disk 68 thru channel 72 and dispenser chute 32, then out the payout tray 30. There may also exist other means of gaining access to reset switch 80. The entire contents of the hopper 42 can be taken in a single operation.

Referring in detail now to FIG. 4, candle 88 is typically connected to circuit board assembly 44 via connectors 102 and 108 (e.g., with at least two conductors). These types of connectors usually have male and female versions. They may be generally referred to as “Molex®” connectors, named after one of the industry leaders. It would be uniquely inventive to tap this local alarm circuit, and use the resulting alarm signal to notify the well-monitored central security system 124. For standardization and simplification of modification, it would be desirable to add “T” link assembly 100, to candle circuit connections 102 and 108. Ideally this assembly 100 would have a male plug 106 on one leg, directly linked/connected in parallel to the female plug 104 on another leg, and an isolation input, such as relay 116 or an opto-coupler circuit (not shown) connected directly in parallel 112 to the central alarm 124 circuit on the third leg of assembly 100. In a preferred embodiment, this is a pluggable upgrade, where connector 106 of the inventive device may be attached to connector 108 of the machine 20, connector 104 may be attached to connector 102, and relay 116 is preferably connected to the central station alarm 124 circuit (e.g., with double spade connectors). The power being sent to the candle 100 would still go directly to the candle 100, but could also branch out to relay 116, which could isolate the voltage and make a “dry contact” or “open circuit” closure to alert the central security system 124 of a breach of machine 20. The power requirements of such a system are negligible. The specific wiring approach may take any usable form and one skilled in the art, with the benefit of the disclosure herein, may choose a different specific wiring approach, yet effectively achieve the same results. The same design approach may be implemented into new machines as well.

Relay 116 may be of any such industry type, including a mechanical relay with contacts 118 or an opto-coupler system. Opto-couplers come in many varieties such as optically isolated solid-state relays and optically isolated transistors. In this case the coil winding 114 of a mechanical relay could be replaced with an optical transmitter such as an LED. The contacts 118 of mechanical relay 116 could be replaced with a phototransistor. This approach may provide for a better link between the alarm systems.

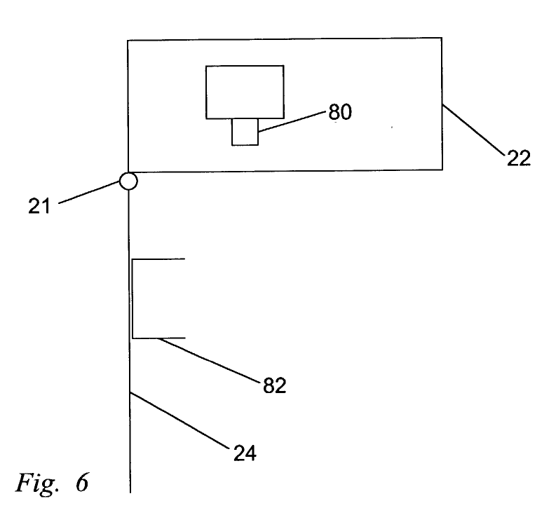

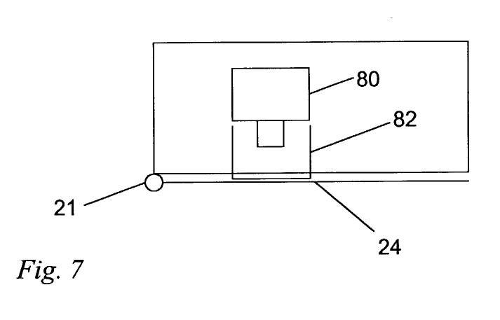

In another preferred embodiment of the inventive protection system, as shown in FIGS. 2,6,7,8, a protective cover 82 can be mounted directly over reset switch 80 (e.g., attached to door 24). When door 24 (FIG. 7) is in the closed position, cover 82 would then surround and protect the reset switch 80. With the inventive guard 82 in place, a slot cheats tool would strike protective cover 82, such that the tool could not be used on reset switch 80 and therefore could not be used to place machine 20 into test mode. When door 24 (FIG. 6) is opened, e.g. via door hinge 21, the protective cover 82 could swing away with door 24, giving a maintenance worker complete access to button 80. This allows for an easy in-field retrofit. Protective cover 82 may also take other forms, for example, such as a flip-away cover mounted to channel 72 (not shown), or the case of circuit board assembly 44 (FIG. 8). Ideally, when the reset button 80 (FIG. 8) is situated away from the door, optional hinge 81 and cover 82 can be easily movable (e.g., lowered) to cover the reset switch 80. Other approaches may include a cap latching system (not shown), a twist lock cover (not shown), or other protective means. The cover could also snap into the circuit board assembly 44 or on other parts of gaming machine 20. One knowledgeable in the art may design this or other protective cover systems.

A similar variation to the above approach, e.g., because some machines may have placed their reset button 80 (FIG. 8) away from the door hinge 21 (FIG. 6), the “hopper test” mode may also be implemented by slot cheats using a different front-end technique. The slot cheat may put a bent coin in the coin slot so as to jam the machine. When a maintenance worker comes to dislodge the coin, he of course has to open door 24, wherein the slot cheat is able to observe the location of the various central alarm switches 84 that go to the central alarm 124. Machines 20 in any given casino typically all use the same key for ease of maintenance. It is known that copies of these keys may be obtainable in the slot cheat subculture. Again, the slot cheat may first drop an opaque but matching cover over the “candle” 88 to render it ineffective. The slot cheat then uses one of the copied keys to unlock door 24. Before opening the door, the cheat may simply slide playing cards through the door seam, and thereby hold back the refrigerator door style switches 84, that have been previously observed. The slot cheat can then open the door, hit the reset button 80 the same “given” number of times, and then press the spin wheel button 52 or pull down on the pull-handle 34. As before, as long as either is held down, the hopper disgorges its' contents out on to payout tray 30. Again, inventive assembly 100 would be extremely valuable in detecting such a scheme. Since time is of the essence in opening and closing door 24 (e.g., before detection by security personnel) assembly 100 may have locking connectors and/or other tamper resistive schemes, all of which are well known in the art.

It should be noted that some machines 20 (slot or otherwise) may not tie internal switch sensor 86 to the tilt sensor system of machine 20. Assembly 100 could be used to bridge local alarm sensor 86 to the machine's “tilt” mechanism, thereby disabling further operation of the machine until reset by an employee of the casino. This may be used separately, or in combination with the central alarm system.

It should also be noted that prior art coin hopper/feeder assembly 42 has a fully enclosed opaque enclosure, and as such, one cannot view the contents inside. This leads to a problem wherein when the gaming machines coin counters match, the maintenance personnel may assume the balance of the coins are residing in the hopper 42, when in fact the hopper may actually be empty, or near empty. This would force the casino to individually count each and every hopper 42. It would be a valuable addition to the art to have a more transparent hopper. This new hopper may include visual means to quickly show the amount of money stored in the hopper (e.g., a hopper with multiple coin tubes containing markings or holes to denote the amount of money stored therein and/or possibly electronic measuring means, e.g., such as weight, ultra wide-band, optical distancing or ultrasonic distancing).

It will be apparent to those skilled in the art that the inventive device is not limited to the embodiments discussed hereinabove, the main inventive aspect being the prevention or detection of the placement of an object into the machine to attempt to access the system's reset mechanism.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention.

What is claimed is:

1) A gaming security system for connecting two electronic security systems comprising:
a gaming machine;
a local security system based in said gaming machine; and
a central security system based in a facility,
wherein a link exists to connect said local security system and said central security system.

2) The gaming security system of claim 1, wherein said link comprises isolation circuitry.

3) The gaming security system of claim 1, wherein said link comprises a relay.

4) The gaming security system of claim 1, wherein said link comprises opto-isolator circuitry.

5) An improved security system for a gaming machine of the type having a reset button
comprising, a reset button cover, wherein said reset button cover is movable, and can be positioned so to protect said reset button from tampering.

6) The improved security system of claim 5, wherein said reset button cover is mountable on the inside of the door of said gaming machine.

7) The improved security system of claim 5, wherein said reset button cover includes a hinge.

8) The improved security system of claim 5, wherein said reset button cover is connected to the circuit board enclosure of said gaming machine.
